(19) United States
(12) Patent Application Publication
(10) Pub. No.: US 2026/0224961 A1
(43) Pub. Date: Aug. 6, 2026

(54) Apparatus, System and Method for Training Ground Reaction Forces

(71) Applicant: Christopher Jayson Nickol, Winnipeg (CA)

(72) Inventor: Christopher Jayson Nickol, Winnipeg (CA)

(21) Appl. No.: 19/413,660

(22) Filed: Dec. 9, 2025

Related U.S. Application Data
(60) Provisional application No. 63/730,712, filed on Dec. 11, 2024.

(51) Int. Cl. A63B 69/36; A63B 71/06

(52) U.S. Cl. CPC A63B 69/3667; A63B 71/0622; A63B 2069/367; A63B 2071/0647; A63B 2214/00; A63B 2220/52; A63B 2220/833

(57) ABSTRACT

A method for training ground reaction forces in a golf swing, the method comprising: contacting in a first position a first push surface; sliding to a second position proximate a second push surface; contacting in the second position a second push surface; sliding to a third position proximate an intersection formed by the first push surface and a third push surface; contacting in the third position at least one of the first and third push surfaces; and sliding to fourth position.

### CROSS REFERENCE TO RELATED APPLICATIONS

This application claims a benefit of, and priority to, U.S. Patent Application 63/730,712, filed Dec. 11, 2024, the contents of which is incorporated by reference in its entirety.

### TECHNICAL FIELD

This disclosure generally relates to a method, apparatus, and system for training ground reaction forces, more specifically, for training ground reaction forces in a golf swing.

### BACKGROUND

In a given golf swing, a dynamic and complex sequence of movements plays a critical role in the accuracy, efficiency, and power of the resulting shot. One movement in the golf swing involves a golfer pushing against the ground, the ground responding with an equal and opposite force-commonly referred as a ground reaction force. Ground reaction forces impact a golfer's ability to transform potential energy to kinetic energy.

Certain technological advances through the use of force plates and launch monitors allow for the measurement of these forces in three dimensions and optimization of a golfer's ground reaction forces. Thus, while an ideal golf swing varies from golfer, certain ground reaction forces in a golf swing can be measured, trained, and optimized. Optimized ground reaction forces may in turn lead to increased swing speed and skill level.

### SUMMARY

A system for training a swing characteristic in a golf swing, the system comprising: a trainer having a slidable training surface; a sensor for measuring and communicating the swing characteristic generated by a golfer using the trainer; and a connected device configured to receive and display to the golfer a representation of the swing characteristic generated during training.

An apparatus for training golfer ground reaction forces, the apparatus comprising: a training surface; a push surface proximate the training surface, wherein the training surface and push surface are configured to optimize the golfer ground reaction forces.

A method for training ground reaction forces in a golf swing, the method comprising: contacting in a first position a first push surface; sliding to a second position proximate a second push surface; contacting in the second position a second push surface; sliding to a third position proximate an intersection formed by the first push surface and a third push surface; contacting in the third position the first and third push surfaces; and sliding to fourth position.

### BRIEF DESCRIPTION OF DRAWINGS

The disclosed examples have other advantages and features which will be more readily apparent from the detailed description, the appended claims, and the accompanying figures (or drawings). A brief introduction to the figures is below.

FIG. 1 is a pictorial representation of the various positions of a golf swing.

FIGS. 2A-2C depicts the ground reaction forces generated during several exemplary golf swings.

FIG. 3A is a top plan view of a golf swing ground reaction force trainer.

FIG. 3B is a front elevation view of the golf swing ground reaction force trainer shown in FIG. 3A.

FIG. 3C is a rear elevation view of the golf swing ground reaction force trainer shown in FIG. 3A.

FIG. 3D is a left side elevation view of the golf swing ground reaction force trainer shown in FIG. 3A.

FIG. 3E is a rear elevation view of another example of a golf swing ground reaction force trainer.

FIG. 3F is a left side elevation view of the golf swing ground reaction force trainer shown in FIG. 3E.

FIG. 4A is a top plan view of another example of a golf swing ground reaction force trainer.

FIG. 4B is a front elevation view of the golf swing ground reaction force trainer shown in FIG. 4A.

FIG. 4C is a rear elevation view of the golf swing ground reaction force trainer shown in FIG. 4A.

FIG. 4D is a side elevation view of the golf swing ground reaction force trainer shown in FIG. 4A.

FIG. 5A is a top plan view of another example of a golf swing ground reaction force trainer.

FIG. 5B is a front elevation view of the golf swing ground reaction force trainer shown in FIG. 5A.

FIG. 5C is a rear elevation view of the golf swing ground reaction force trainer shown in FIG. 5A.

FIG. 5D is a side elevation view of the golf swing ground reaction force trainer shown in FIG. 5A.

FIG. 6 shows the golf swing ground reaction force trainer of with the golfer in a first position proximate a first push surface.

FIG. 7 shows the golf swing ground reaction force trainer of FIG. 6 with the golfer in a second position proximate a second push surface.

FIG. 8 shows the golf swing ground reaction force trainer of FIG. 6 with the golfer in a third position proximate a corner formed by first and third push surfaces.

FIG. 9 shows the golf swing ground reaction force trainer of FIG. 6 with the golfer in a fourth position rotated away from the first and third push surfaces.

### DETAILED DESCRIPTION

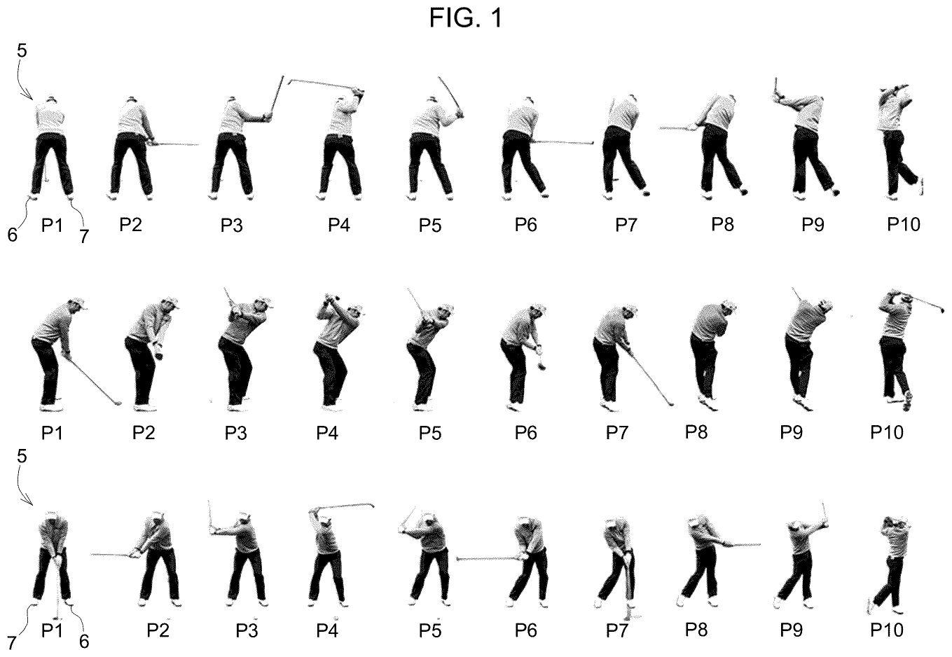

Ground reaction forces (“GRF”) of a golfer in a golf swing typically involve combinations of vertical forces, horizontal shear forces and rotational torques, each of which may vary at different positions in the golf swing. Different positions of the golf swing may involve bending, extending, or jumping motions which can increase or decrease a GRF, generally through the lead and trail feet of the golfer. A golf swing is shown in FIG. 1 and comprises various positions (P1-P10) as follows:
P1: Address
P2: Takeaway
P3: Halfway Back
P4: Top of the Backswing
P5: Early Downswing
P6: Pre-Impact
P7: Impact
P8: Release
P9: Finish
P10: End of Swing

Horizontal forces, or shear forces, are critical for lateral movements. Horizontal forces help in shifting the center of mass, facilitating weight transfer from the backswing to the downswing. Rotational torques result in part from horizontal forces acting in opposite directions at the lead foot and trail foot. Torque is necessary for rotational movement in the golf swing, this rotational force acting around a generally vertical axis of the golfer creates clubhead speed and increased shot distances. Vertical forces are influenced by gravity and golfer's mass and change dynamically during a swing.

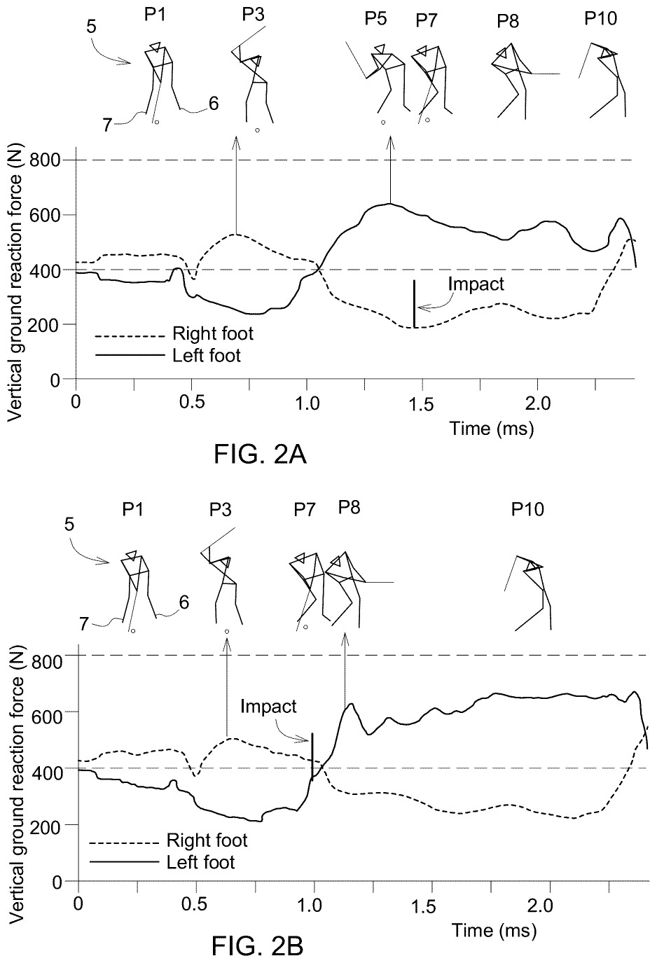

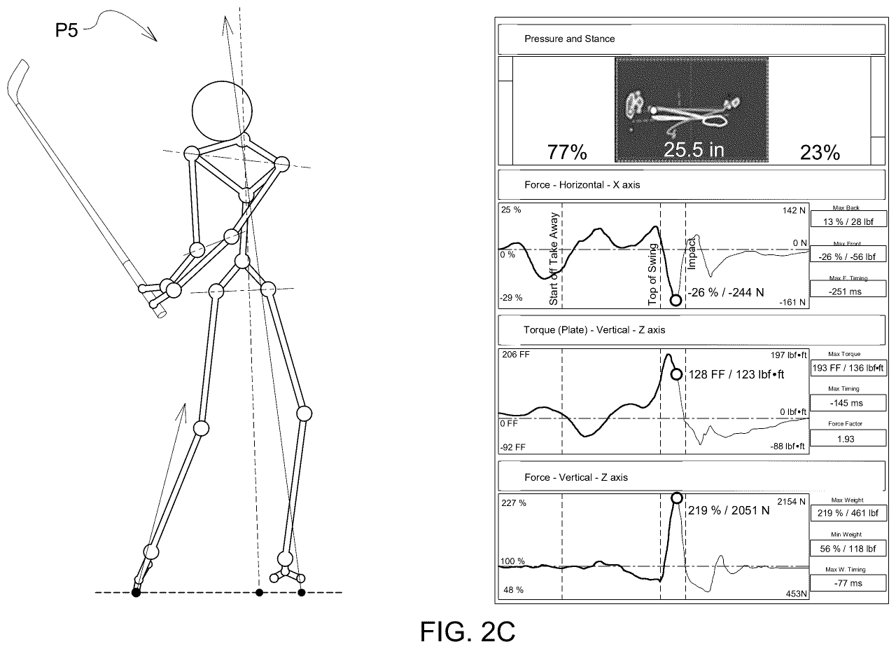

Referring now to FIG. 2A-2B, at address (P1), the vertical GRF is roughly equal to the golfer's mass plus gravity. With respect to FIG. 2A-2B, and for a right-handed golfer 5, lead foot 6 is the left foot and the trail foot 7 is the right foot. For example, and as can be seen by the right foot line, a golfer 5 applies a higher vertical force with the trail foot 7 as compared to the lead foot 6 during the backswing (P2-P4) and applies a higher vertical force with the lead foot 6 as compared to the trail foot 7 during the downswing (P5-P7).

Training the different ground reaction force components with respect to an amount of force (e.g., maximum vertical force), rate of force production (e.g., the slope of that force trace as it peaks) and timing of that force production (e.g., P1-P10) correlates positively with swing speed and skill level. FIG. 2A depicts a maximum vertical force occurring approximately at P5—which is desirable. Ground reaction forces that are generated too late, as seen in FIG. 2B, negatively correlate with swing speed and skill level. FIG. 2B depicts maximum vertical force occurring at P8-P10, which is too late to positively correlate with swing speed and skill level.

As an example, FIG. 2C depicts generally optimal horizontal, torque and vertical forces generated by a golfer 5 during the various positions P1-P10 of the golf swing. Trainer 10 can be utilized to train and optimize the amount, rate and timing of the ground reaction forces (horizontal, vertical and torque) of a golfer such that they will better resemble the ideal GRF shown in FIG. 2C. Trainer 10 may utilize a slidable training surface and push surfaces around the periphery of the training surface to optimize the amount, the rate and timing of vertical force production. Specifically, trainer 10 trains and optimizes the maximum vertical force production and the timing at which maximum vertical force production occurs, specifically the P5 swing position. Trainer 10 may also use an associated sensor such as force plates (vertical, lateral, anterior-posterior) to measure vertical force production.

In another example, trainer 10 trains the amount, rate, and timing of the horizontal force. Trainer 10 utilizes a slidable training surface and push surfaces around the periphery of the training surface to optimize the amount, the rate and timing of horizontal force production. In one example, trainer 10 trains the maximum horizontal force production and the timing at which maximum horizontal force production occurs (e.g., between top of swing and impact). Trainer 10 may also use an associated sensor such as force plates (vertical, lateral, anterior-posterior) to measure horizontal force production.

In yet another example, trainer 10 trains the amount, rate, and timing of torque (rotational force). Trainer 10 utilizes a slidable training surface and push surfaces around the periphery of the training surface to optimize the amount, the rate and timing of torque production. In one example, trainer 10 trains the maximum torque production and the timing at which maximum torque production occurs (e.g., between the top of swing and impact). Trainer 10 may also use an associated sensor such as force plates (vertical, lateral, anterior-posterior) to measure torque force production.

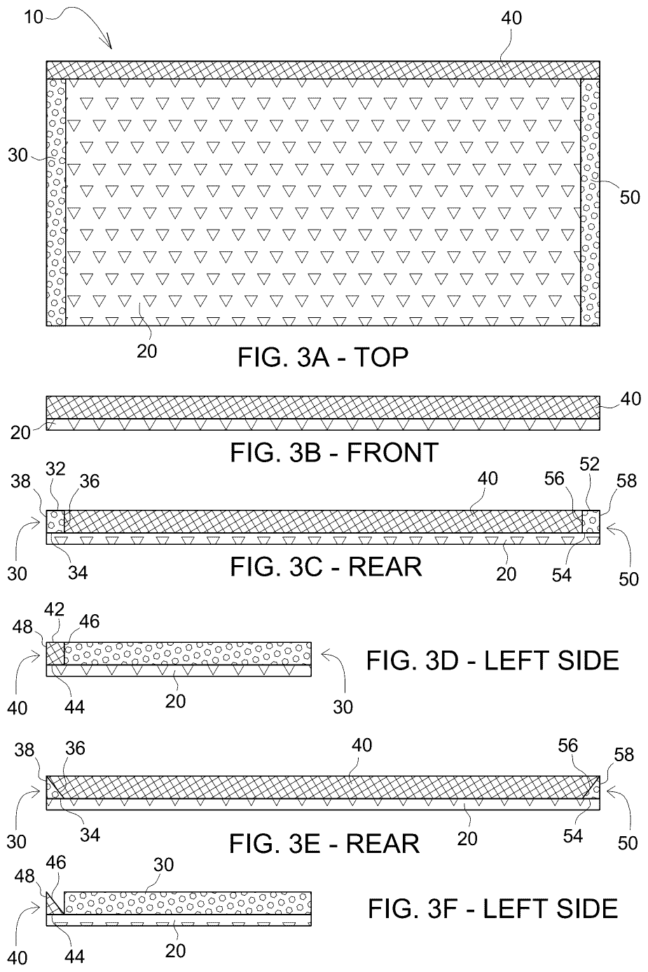

Referring now to FIGS. 3A-3D, a top, front, rear, and side views of a golf swing GRF trainer 10 are shown. In this example, trainer 10 comprises a training surface 20 and one or more configurable push surfaces 30, 40, 50 along the perimeter of the training surface 20. Trainer 10 may be stationary or portable depending upon the needs of the golfer 5. In one example, training surface 20 is supported by a firm or rigid member placed between the training surface 20 and the ground (not shown) to improve the rigidity and resiliency. Training surface 20 may be formed of high-density polyethylene (HDP) or other suitable surface providing a low-friction slidable surface for golf movements. The top side (i.e., the side which the golfer 5 stands on) of training surface 20 presents a low-friction surface upon which a golfer 5 can easily slide to execute a golf movement to optimize GRF. In another example, a golfer 5 may wear footwear (not shown) which reduces frictional forces to facilitate sliding on the top side of training surface 20. In yet another example, the training surface can easily be cleaned with wiped or cleaned with a cleaning agent. In further examples, a light coat of Teflon® or silicone spray can be added to a training surface 20 to decrease friction and increase slidability.

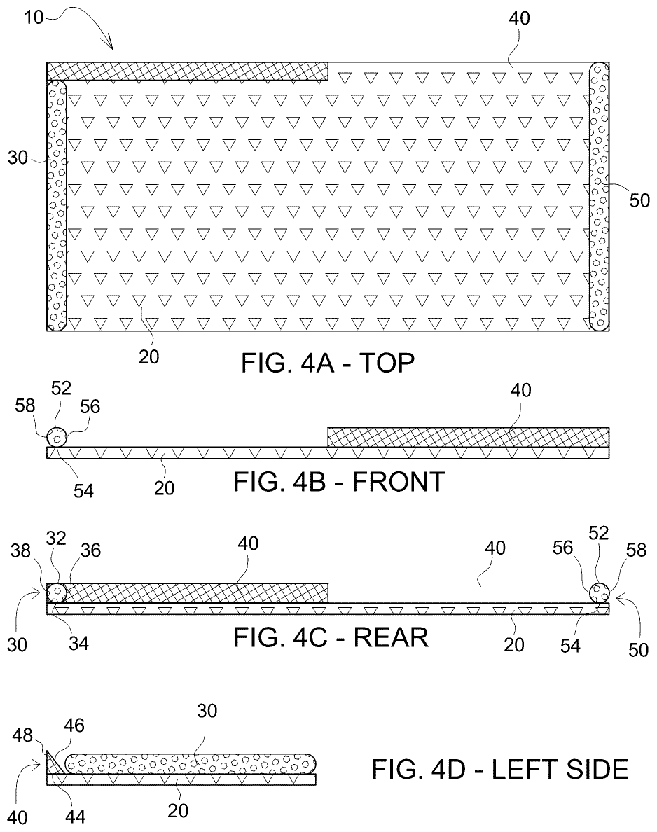

In one example as shown FIGS. 3A-3D, trainer 10 includes one or more push surfaces 30, 40, 50 attached or affixed to one or more edges of training surface 20. Push surface 30, 40, 50 may be configured to help train a golfer 5 to push against the respective one or more push surface with a lead and/or train foot, as appropriate, during the golf swing. Push surfaces 30 and 50 are similar in length being approximately equal to or less than the width of training surface 20. In one example, push surfaces 30 and 50 are approximately 24-40 inches in width. Push surface 40 may have a length approximately equal to or less than the length of training surface 20—which in one example is around 40-56 inches in length. However, it can be appreciated by one of ordinary skill and as shown in FIG. 4A, that the length of push surfaces 30, 40, 50 may vary according to training needs including being greater than or less than the dimensions of training surface 20.

In can also be appreciated by one of ordinary skill that the length and width of each push surface may vary in relation to another and to training surface 20 depending upon the training needs of a golfer 5. Further, the materials and construction for each of these surfaces may vary to include unitary or multi-part construction and/or comprise materials with solid or hollow construction and which are rigid or compressible For example, contact zones (36, 46, 56) may be of a more rugged material and/or may incorporate various sensors to measure GRF and/or a time in contact with the surface by a golfer 5.

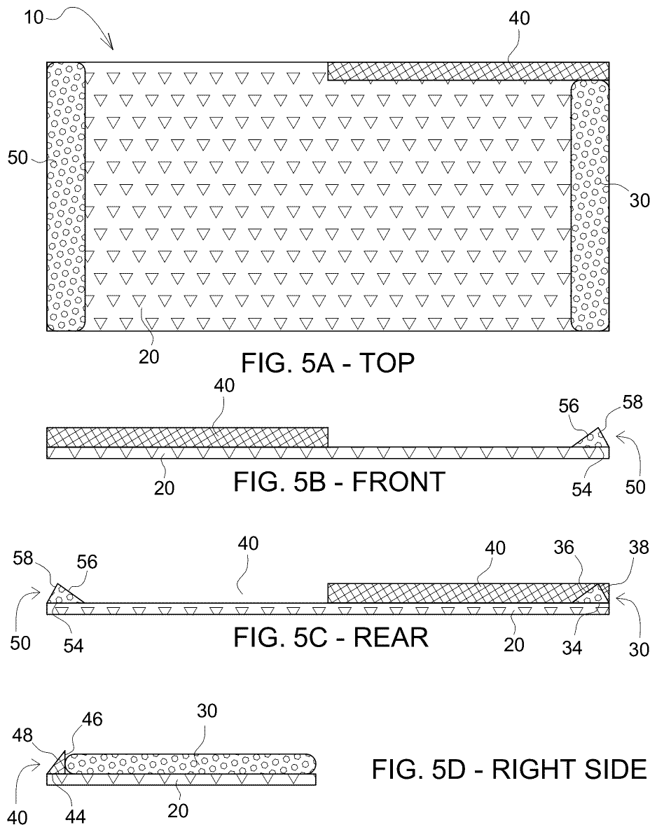

The push surfaces 30, 40, 50 are, in one example, unitary in construction as shown in FIG. 4. However, they may also be multi-part construction and constructed such that there are substantial hollow interior spaces. Push surfaces 30, 40, 50 may be lightweight and removably attached to the training surface to allow for configuration and reconfiguration according to a golfer's handedness (right or left) or according a desired training protocol. When attached to training surface 20, the push surfaces 30, 40, 50 are oriented with bottom surfaces 34, 44, 54 respectively being flush with a top side of the training surface 20. In this manner, push surfaces 30, 40, 50 may be configured to accommodate the training needs of different golfers. For example, FIG. 4A shows a trainer 10 configured for a right-handed golfer 5 (push surface 40 abuts push surface 30) while FIG. 5A shows a trainer 10 for a left-handed golfer (push surface 40 abuts push surface 50).

Push surfaces 30, 40, 50 may be of a similar geometry or may be different geometries depending upon the training needs of a golfer 5. For example, with respect to FIGS. 3A-3D, push surfaces 30, 40, 50 may each be generally rectangular in shape to present a generally vertical surface to a lead or trail foot of a golfer 5. When in a rectangular shape, push surfaces 30, 40, 50 comprise, respectively, top surfaces (32, 42, 52), bottom surfaces (34, 44, 54), contact zones (36, 46, 56) and back surfaces (38, 48, 58).

In another example, as shown in FIGS. 3E, 3F, 4D, 5B, 5C and 5D, at least one of the push surfaces 30, 40, 50 are wedge-shaped. With respect to FIGS. 3E-3F, each push surface comprises respectively a bottom surface (34, 44, 54), a contact zone (36, 46, 56) and a back surface (38, 48, 58). In yet another example, as shown in FIGS. 4B, 4C and 5C, push surfaces 30, 40, 50 may be constructed with a 2D shape including but not limited to a circle, semi-circle, square, oval, oblong, triangle (e.g., right triangle, acute triangle, equilateral triangle, scalene triangle, isosceles triangle), parallelogram, trapezoid, rhombus, pentagon, hexagon, heptagon, octagon, multigon or any other indeterminate or irregular shape. Consequently, push surfaces 30, 40 50 also comprise a plurality of 3-D shapes including but not limited to a cuboid, pyramid, triangular prism, rectangular prism, hexagonal prism, sphere, hemisphere, cone, polyhedron, and cylinder. Again, depending on the shape, each push surface would have at least a bottom surface (34, 44, 54), a contact zone (36, 46, 56) and a back surface (38, 48, 58).

Accordingly, the trainer 10, training surface 20 and push surfaces 30, 40, 50 may vary in dimensions, shape, construction, and materials. As previously described, push surfaces 30, 40, 50 may vary individually or in combination to present different contact zones 36, 46, 56 to a lead or trail foot of a golfer 5. For example, when the push surface 40 is a right triangle, it is generally the case that when a foot 6, 7 of the golfer 5 contacts the contact zone 46 of push surface 40 it is more gradual and gentler as compared to a push surface with a generally vertically contact zone.

Further, the contact zone 36, 46, 56 may be inclined at an angle such that a foot of golfer 5 is brought to a stop while protecting the golfer 5 (e.g., ankles, knees, hips, etc.) and allowing the golfer 5 to maximally push off. This angle may range from 0 to 90 degrees, depending upon the golfer 5 and the type and level of training being performed on the trainer 10. Again, inclination angles for contact zones 36, 46, 56 may vary individually or in combination to optimize performance for an individual golfer 5. For example, contact zone 36 may be at an angle of 90 degrees while contact zones 46, 56 may be an angle of 20 degrees. In another example, contact zone 36 may be at angle of 30 degrees while contact zone 46 is at an angle of 90 degrees and contact zone 56 is at angle of 90 degrees. It can be appreciated by one of ordinary skill the contact zones may have any number of combinations of inclination angles and/or geometries.

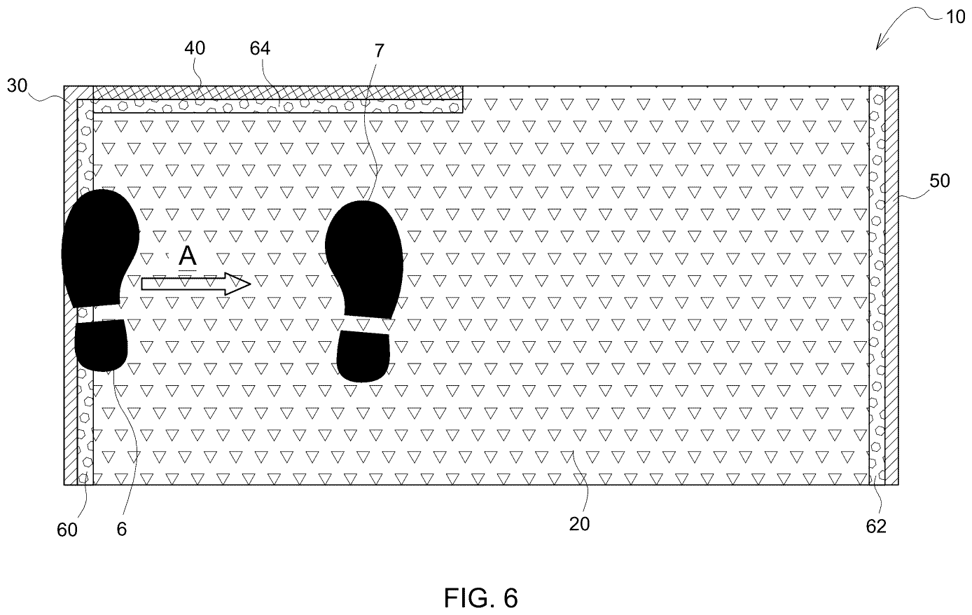

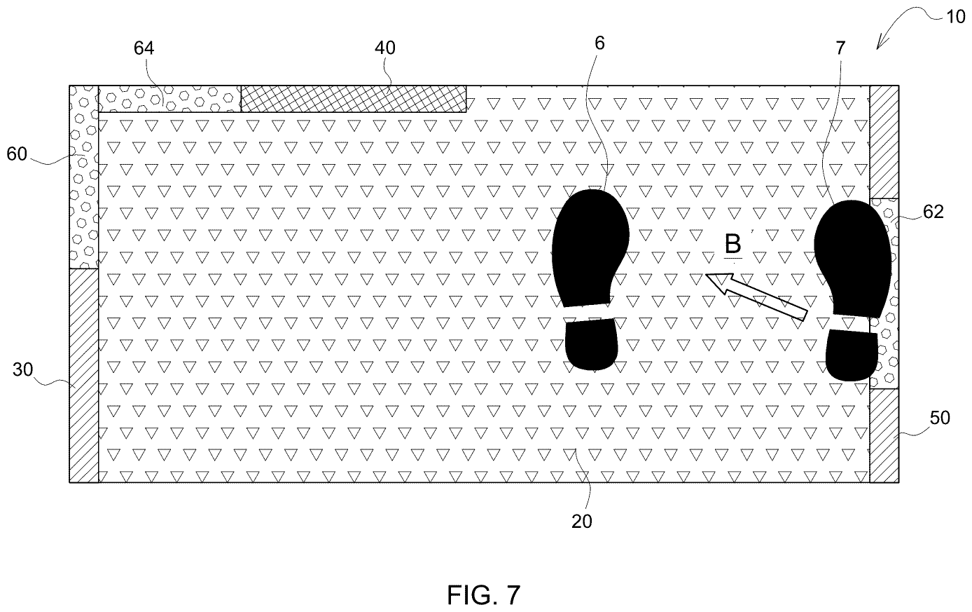

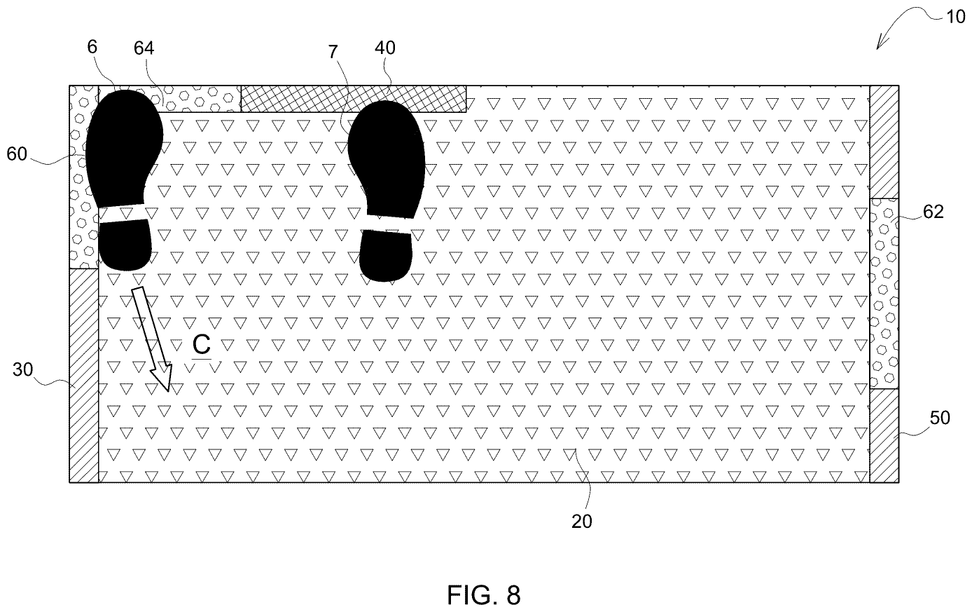

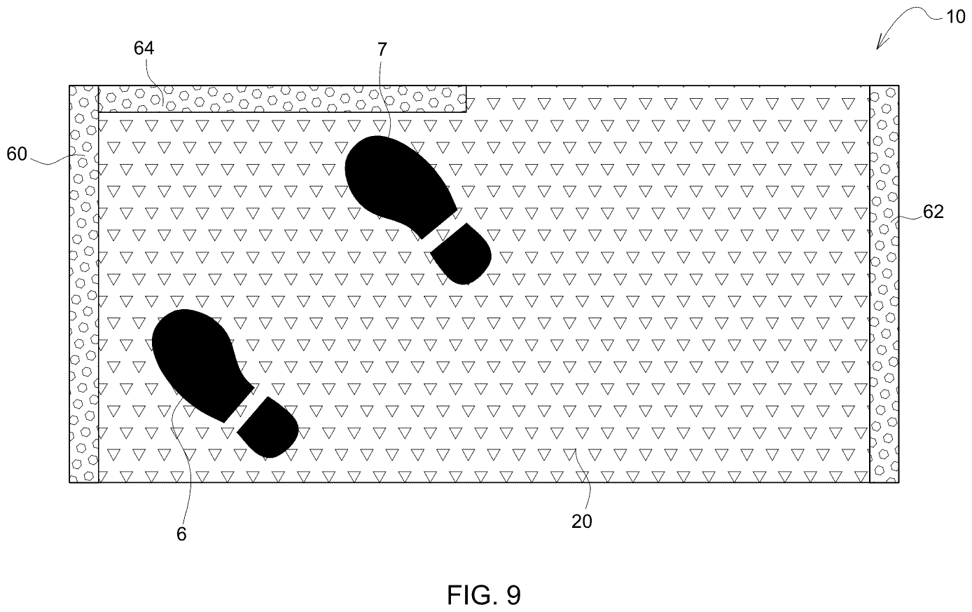

Turning to the use of trainer 10 by a golfer 5, and as best seen in FIGS. 6-9, a right handed golfer's lead and trail feet move across the training surface 20 and push against the one or more of the contact zones 36, 46, 56 of push surfaces 30, 40, 50. In one example, as shown in FIG. 6, push surface 30 trains at least one of a horizontal, vertical, and rotational in a direction of travel (arrow A) from a lead foot 6 and which is first in the sequence of pushes/movements. Referring to FIG. 7, push surface 50 trains at least one of a horizontal, vertical, and rotational GRF in a direction of travel (arrow B) from trail foot 7 and is second in the sequence of pushes/movements. FIG. 8 depicts push surface 50 (alone or in combination with push surface 30) training at least one of a horizontal, vertical, and rotational GRF in a direction of travel (arrow C) from a lead foot 6 and is third in the sequence of movements. FIG. 9 depicts an approximate final position of lead foot 6 and trail foot 7 of golfer 5.

Reference is now made to the steps by which trainer 10 can be used to train appropriate GRF throughout the various positions (P1-P10) of a golf swing:
1) As seen in FIG. 6, a right-handed golfer 5 starts with their lead foot 6 against push surface 30 at a contact zone 36 which may comprise first sensor 60. The swing position of the golfer 5 is generally equivalent to Pl in FIG. 1.
2) The golfer 5 initiates movement by pushing with lead foot 6 against contact zone 36. The swing position of the golfer 5 is generally equivalent to P2-P3 of FIG. 1.
3) As seen in FIG. 7, golfer 5 then slides across training surface 20 such that trail foot 7 is now proximate push surface 50 at a contact zone 56 which may comprise second sensor 62.
4) The golfer 5 then pushes with trail foot 7 against contact zone 56 of push surface 50. The swing position of the golfer 5 is generally equivalent to P4 in FIG. 1.
5) As shown in FIG. 8, golfer 5 slides across training surface 20 such that lead foot 6 is now proximate a corner formed by push surfaces 30, 40 at a contact zone 36, 46 which may comprise first sensor 60, third sensor 64, respectively.
6) The golfer 5 then pushes with lead foot 6 against one or both contact zones 36, 46 of push surfaces 30, 40 to create a slide as shown by arrow C across training surface 20. The swing position of the golfer 5 while pushing against one or both contact zones 36, 46 is generally equivalent to P5 in FIG. 1. The subsequent rotational slide is generally away from the corner formed by push surfaces 30, 50.

Additionally, the push surfaces 30, 40, 50 may be constructed or retrofitted with one or more components allowing for hardwired connection or connectivity over cellular, WiFi or BlueTooth networks. In this example, push surfaces 30, 40, 50 may be configured with one or more sensors 60, 62 and 64 to measure forces generated at the contact zones 36, 46, 56 and/or length of time that a golfer 5 contacts the contact zones 36, 46, 56. In one example, and as shown in FIG. 6, sensors 60, 62, 64 are Swing Catalyst motion plates integrated within the dimensions (including but not limited to a contact zone 36, 46, 56) of one or more push surfaces 30, 40, 50. FIGS. 7-9 depict additional configurations of sensors 60, 62, 64 relative to the dimensions of one or more push surfaces 30, 40, 50. In this manner, a 3-D ground reaction force reading can be obtained at one or more of the push surfaces 30, 40, 50. GRF and/or time readings can then be transmitted wirelessly to a connected device such as smart phone, tablet or computer. In another example, push surfaces 30, 40, 50 are provided with a visual or audible indicator to provide an alert based on acceptable GRF, time in contact with the push surface or some other sensed characteristic relevant to the training being provided on trainer 10.

Sensors 60, 62, 64 may be capable of detecting force, load, tension, and compression forces on the trainer 10. Other sensed data may include acceleration, velocity, global absolute displacement, local relative displacement, rotation, strain, stress, force, static-position and moving-position video, temperature, mass loading, static tilt, and fatigue. A force is simply a push or pull to an object and can be detected by a load cell, pressure cell or strain sensor. A load is simply a force applied to the trainer 10. Tension and compression are internal forces that make a member longer or shorter, respectively.

In still yet another example, a golfer 5 may utilize a smart wearable or other IOT device capable of sensing and recording parameters of the golfer's movement while using trainer 10. In another example, the sensed and recorded parameters of the golfer's movement while using the trainer 10 are compared to sensed parameters of a professional's movement to improve and optimize ground reaction forces. For example, the golfer 5 may wear a smart watch or fitness watch having one or more of a camera, accelerometer, gyroscope, or any other suitable sensor of detecting parameters of the golfer's movement and transmitting the detected parameters back to a connected device for display and analysis by the golfer 5 and/or coach. In this manner, a GRF of golfer 5 can be analyzed and compared throughout any of the various positions P1-P10.

### Additional Configuration Considerations

In the description above, for purposes of explanation, numerous specific details are set forth in order to provide a thorough understanding of the illustrated system and its operations. It will be apparent, however, to one skilled in the art that the system can be operated without these specific details. In other instances, structures and devices are shown in block diagram form in order to avoid obscuring the system.

Reference in the specification to “one example” or “an example” means that a particular feature, structure, or characteristic described in connection with the example is included in at least one example of the system. The appearances of the phrase “in one example” in various places in the specification are not necessarily all referring to the same example.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer physically mounted within a machine. This computer may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer readable storage medium suitable for storing electronic instructions.

The figures and the description above relate to numerous examples by way of illustration only. It should be noted that from the following discussion, alternative examples of the structures and methods disclosed herein will be readily recognized as viable alternatives that may be employed without departing from the principles of what is claimed.

One or more examples have been described above, examples of which are illustrated in the accompanying figures. It is noted that wherever practicable similar or like reference numbers may be used in the figures and may indicate similar or like functionality. The figures depict examples of the disclosed system (or method) for purposes of illustration only. One skilled in the art will readily recognize from the following description that alternative examples of the structures and methods illustrated herein may be employed without departing from the principles described herein.

Some examples may be described using the expressions “coupled” and “connected” along with their derivatives. It should be understood that these terms are not intended as synonyms for each other. For example, some examples may be described using the term “connected” to indicate that two or more elements are in direct physical or electrical contact with each other. In another example, some examples may be described using the term “coupled” to indicate that two or more elements are in direct physical or electrical contact. The term “coupled,” however, may also mean that two or more elements are not in direct physical or electrical contact with each other, but yet still co-operate or interact with each other. The examples are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

In addition, the use of “a” or “an” is employed to describe elements and components of the examples herein. This is done merely for convenience and to give a general sense of the system. This description should be read to include one or at least one and the singular also includes the plural unless it is obvious that it is meant otherwise.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Upon reading this disclosure, those of skill in the art will appreciate additional alternative structural and functional designs for a system, apparatus, and a process for localization within an orchard. Thus, while particular examples and applications have been illustrated and described, it is to be understood that the disclosed examples are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

What is claimed is:

1. A system for training a swing characteristic in a golf swing, the system comprising:
a trainer having a slidable training surface;
a sensor for measuring and communicating the swing characteristic generated by a golfer using the trainer; and
a connected device configured to receive and display to the golfer a representation of the swing characteristic generated during training.

2. The system of claim 2 wherein the swing characteristic is a time in contact with the trainer by the golfer.

3. The system of claim 3 wherein an alert is presented to the golfer on the connected device representative of the time in contact with the trainer.

4. The system of claim 1 wherein the trainer comprises at least one push surface proximate the slidable training surface.

5. The system of claim 4 wherein the swing characteristic is a ground reaction force, and an alert is displayed on the connected device representative of the ground reaction force at the push surface.

6. The system of claim 5 wherein the sensor is a force plate associated with the push surface, the sensor measuring the ground reaction forces acting between a foot of the golfer, the force plate, and the training surface.

7. The system of claim 6 wherein the push surface is configured with a geometry comprising at least one of a cuboid, pyramid, triangular prism, rectangular prism, hexagonal prism, sphere, hemisphere, cone, polyhedron, and cylinder geometry.

8. The system of claim 7 wherein the push surface is formed in a multi-part construction.

9. The system of claim 7 wherein the push surface is formed in a multi-material construction.

10. An apparatus for training golfer ground reaction forces, the apparatus comprising:
a training surface;
a push surface proximate the training surface, wherein the training surface and push surface are configured to optimize the golfer ground reaction forces.

11. The apparatus of claim 10 wherein the training surface is a slidable surface.

12. The apparatus of claim 11 wherein the training surface and push surfaces are configured to optimize the golfer ground reaction force at a P5 position.

13. The apparatus of claim 12 wherein the training surface is proximate a first push surface, a second push surface and a third push surface.

14. The apparatus of claim 13 wherein the golfer contacts in a first position the first surface.

15. The apparatus of claim 14 wherein the golfer contacts in a second position the second push surface.

16. The apparatus of claim 15 wherein the golfer contacts in a third position at least one of the first push surface and the third push surface.

17. The apparatus of claim 16 wherein the golfer contacts in the third position the first push surface and the third push surface to optimize a rotational ground reaction force.

18. The apparatus of claim 13 wherein the first push surface, second push surface and third push surface are configured with a geometry to optimize the ground reaction force.

19. The apparatus of claim 13 wherein the first push surface, second push surface and third push surface are positioned in relation to one another to optimize the ground reaction force.

20. A method for training ground reaction forces in a golf swing, the method comprising:
contacting in a first position a first push surface;
sliding to a second position proximate a second push surface;
contacting in the second position a second push surface;
sliding to a third position proximate an intersection formed by the first push surface and a third push surface;
contacting in the third position at least one of the first and third push surfaces; and
sliding to a fourth position.
